(19) United States
(12) Patent Application Publication
(10) Pub. No.: US 2019/0279092 A1
(43) Pub. Date: Sep. 12, 2019

(54) Convolutional Neural Network Compression

(71) Applicant: Google LLC, Mountain View, CA (US)

(72) Inventors: Mark Sandler, Mountain View, CA (US); Andrey Zhmoginov, Mountain View, CA (US); Soravit Changpinyo, Los Angeles, CA (US)

(21) Appl. No.: 16/346,313

(22) PCT Filed: Sep. 29, 2017
(86) PCT No.: PCT/US2017/054472

§ 371 Date: Apr. 30, 2019

Related U.S. Application Data
(60) Provisional application No. 62/417,986, filed on Nov. 4, 2016.

(51) Int. Cl. G06N 3/08; G06N 3/04

(52) U.S. Cl. CPC G06N 3/084; G06N 3/0454

(57) ABSTRACT

Systems and methods of convolutional neural network compression are provided. For instance, a convolutional neural network can include an input convolutional layer having a plurality of associated input filters and an output convolutional layer having a plurality of associated output filters. The convolutional neural network implements a connection pattern defining connections between the plurality of input filters and the plurality of output filers. The connection pattern specifies that at least one output filter of the plurality of output filters is connected to only a subset of the plurality of input filters.

### FIELD

The present disclosure relates generally to convolutional neural networks.

### BACKGROUND

Deep neural networks combined with large-scale labeled data have become a standard recipe for achieving state-of-the-art performance on supervised learning tasks in recent years. Despite such successes, the capability of deep neural networks to model highly nonlinear functions comes with high computational and memory demands. In particular, the number of parameters of neural network models is often quite large to account for the scale, diversity, and complexity of data from which the network learns. Such neural networks are often implemented in mobile or embedded devices having limited resources. It can be difficult to balance the size, training time, and prediction accuracy of such networks. While the advances in hardware have somewhat alleviated the issue, network size, speed and power consumption, are all limiting factors when it comes to production deployment on mobile and embedded devices. On the other hand, it is well-known that there is significant redundancy among the weights of neural networks.

In this regard, various neural network compression techniques have been implemented. For instance, one general approach to network compression is a technique called network pruning, wherein a subset of connections of a network are removed from the network. However, if there are no constraints governing the removal of connections and/or parameters, network pruning can result in irregular networks, which can negatively affect training time and memory usage of the network. Further, network pruning can lead to an inflexible model.

Another approach to network compression with the object of trading accuracy for size and speed is a technique called depth multiplier wherein the number of channels in each layer is simply reduced by a fixed fraction and the network is retrained. Depth multiplier includes a constraint wherein every input filter (or channel) must be fully connected to every output filter. Other approaches to network compression include quantization and decomposition techniques. Network regularization can further be performed on such networks. Regularization can include randomly setting a subset of activations to zero during training of the network. Another regularization technique includes randomly setting a subset of weights or connections to zero.

### SUMMARY

Aspects and advantages of embodiments of the present disclosure will be set forth in part in the following description, or may be learned from the description, or may be learned through practice of the embodiments.

One example aspect of the present disclosure is directed to a convolutional neural network. The convolutional neural network includes an input convolutional layer having a plurality of associated input filters and an output convolutional layer having a plurality of associated output filters. The convolutional neural network implements a connection pattern defining connections between the plurality of input filters and the plurality of output filers. The connection pattern specifies that at least one output filter of the plurality of output filters is connected to only a subset of the plurality of input filters.

Another example aspect of the present disclosure is directed to one or more tangible, non-transitory computer-readable media storing computer-readable instructions that when executed by one or more processors cause the one or more processors to perform operations. The operations include accessing data indicative of a connection pattern associated with a convolutional neural network. The connection pattern defines connections between a plurality of first filters associated with a first convolutional layer and a plurality of second filters associated with a second convolutional layer. The connection pattern specifies that at least one of the plurality of second filters is connected to only a subset of the plurality of first filters. The operations further include deactivating one or more connections in the convolutional neural network corresponding to the one or more inactive connections specified by the connection pattern.

Yet another example aspect of the present disclosure is directed to a computer-implemented method of training a convolutional neural network. The method includes performing, by one or more computing devices, a first round of a machine learning training on a convolutional neural network while enforcing a first connection pattern between a plurality of first filters and a plurality of second filters of at least two convolutional layers of the convolutional neural network. The first connection pattern specifies, for each second filter, only a first subset of the plurality of first filters to which the second filter is connected. The method further includes, subsequent to performing the first round of machine learning training, performing, by the one or more computing devices, a second round of the machine learning training on the convolutional neural network while enforcing a second connection pattern between the plurality of first filters and the plurality of second filters of the at least two convolutional layers of the convolutional neural network. The second connection pattern specifies, for each second filter, only a second subset of the plurality of first filters to which such second filter is connected. For each second filter, the second subset includes a larger number of first filters than does the first subset.

Other example aspects of the present disclosure are directed to systems, apparatus, tangible, non-transitory computer-readable media, user interfaces, memory devices, and electronic devices for compressing and training convolutional neural networks.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example system for compressing convolutional neural networks according to example embodiments of the present disclosure;

FIG. 2 depicts a graphical representation of a connection pattern according to example embodiments of the present disclosure;

FIG. 3 depicts a flow diagram of an example method of training a convolutional neural network according to example embodiments of the present disclosure; and

FIG. 4 depicts a flow diagram of an example method of compressing a convolutional neural network according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to compression techniques for convolutional neural networks (CNNs). For instance, such compression techniques can define a partial connection pattern between input and output filters associated with two or more convolutional layers of the CNN. In this manner, one or more connections between filters in convolutional layers of the CNN can be deactivated. More particularly, two-dimensional (2D) convolution techniques can be generalized to use a sparse, yet consistent connection structure. Deep neural networks generally have intensive computational and memory demands. In particular, such deep networks often have a very large number of associated parameters to account for the scale, diversity, and complexity of the data from which the networks learn. While advances in hardware technology have somewhat alleviated the issue, network size, speed, and power consumption are all limiting factors in the implementations of such networks on mobile and/or embedded devices. CNNs according to example aspects of the present disclosure provide balance between size, training time, and prediction accuracy of the CNN.

CNN architectures generally include one or more convolutional layers, pooling layers, and/or fully connected layers. Such layers are configured in accordance with a topology that governs the organization of the layers. One example implementation of the present disclosure includes transforming a given input architecture to a compressed architecture having a smaller number of parameters. Such transformation can be performed based at least in part on a transformation function that maintains the general topology of the input architecture.

It can be shown that scaling down a number of filters in each convolutional layer of a CNN can result in a smaller, faster network resulting in only a small loss of precision. For instance, a depth multiplier techniques can be performed to reduce the layer depth of one or more convolutional layers of a CNN by a fixed fraction. It will be appreciated that the term “depth,” used in this manner refers to the third dimension of an activation volume of a single layer, not the number of layers in the entire CNN. For instance, given a hyperparameter α∈(0, 1], the number of filters in each convolutional layer can be scaled down by α. Let D_{I} and D_{O} be the number of input and output filters, respectively. Consider the spatial location x and y of output activations. For each input filter k ∈{1, . . . , D_{I}} and output filter l ∈{1, . . . , D_{O}}, we have:

α[x,y,l]=Σ_{i=-I}^{I}Σj=−J^{J}w[i,j,k,l]*b[x−i,y−j,k],

where the convolutional kernel for this pair of filters is of size [W=2I +1, H=+1], b is the input, w is the layer parameters, and a is the output.

As D_{I} and D_{O} become ┌αD₁┐ and ┌αD_{O}┐ in the depth multiplier approach, the number of parameters (and the number of multiplications) becomes ≈α2 of the original number. In this regard, any computational savings leveraged before applying the depth multiplier can be trivially harvested. The resulting network is just smaller and faster. Some large networks can be reduced in size using this technique with only small loss of precision. For instance, in some implementations, the depth multiplier technique can be implemented by selecting a multiplier α and scaling down each filter depth by \sqrt{α}, and then rounding up.

As opposed to looking at the depth multiplier as deactivating filters in the convolutional layers, the depth multiplier can be interpreted from the perspective of deactivating connections between filters. In this regard, depth multiplier can deactivate the connections between two or more convolutional layers such that the connection patterns are maintained across the spatial dimensions of the convolutional layers, and that all remaining input filters are fully connected to all remaining output filters.

This approach can be generalized by relaxing the constraint that the remaining input and output filters be fully connected. More particularly, for each spatial dimension, a fixed, sparse random connection pattern between input and output filters can be implemented. In this manner, the connections between the input and output filters can be determined randomly. In this manner, as opposed to a dense connection pattern between a small number of filters as provided in the depth multiplier technique, example aspects of the present disclosure can provide sparse random connections between a larger number of filters. For instance, for an input convolutional layer having D_{I} channels and an output convolutional layer having D_{O} channels, each output filter of the output convolutional layer only connects to an a fraction of input filters of the input convolutional layer. An advantage of this technique is that the convolution can be performed quickly because the sparsity is introduced only at the outer loop of the convolution operations. In this manner, a continuous memory layout can still be used.

In some implementations, the CNN architecture can be implemented by activating connections between input and output filters according to their likelihood from the uniform distribution. In addition, the activation can be performed such that there are no connections going in or coming out of dead filters. In this manner, any connections must have a path to the input image and a path to the final prediction. All the connections in any fully connected layers associated with the CNN are maintained. In some implementations, the CNN architecture can be implemented by randomly deactivating a fraction α of connections having parameters that connect at least two filters on each layer. A fraction \sqrt{α} of connections can be randomly deactivated if the associated parameters connect layers having only one filter left. In some implementations, the connections can be activated and/or deactivated by selectively applying masks to parameter tensors associated with the appropriate filters.

Example aspects of the present disclosure are further directed to training CNNs having partially connected architectures as described above. In particular, an incremental training technique can be performed on such CNNs or other partially connected networks. Such incremental training can begin with a network having a small fraction of connections (e.g. 1%, 0.1%, etc.). Connections can be gradually added over time, such that the network is slowly densified over time as the training process progresses. For instance, connections can be added during one or more training iterations of the training process. Such incremental training can allow networks to use channels that have already been trained in new contexts by introducing additional connections. In this manner, when the network is densified over time by the gradual addition of connections, all channels already possess some discriminative power which can be leveraged in the training process. An advantage of this approach is that, by initiating the training process with a small network, and gradually increasing the size of the network over time, the entire training process can be sped up significantly. It will be appreciated that the depth multiplier technique will not benefit from this approach as any newly activated connections would require training new filters from scratch. Such process can result in the full training time being comparable to training from scratch.

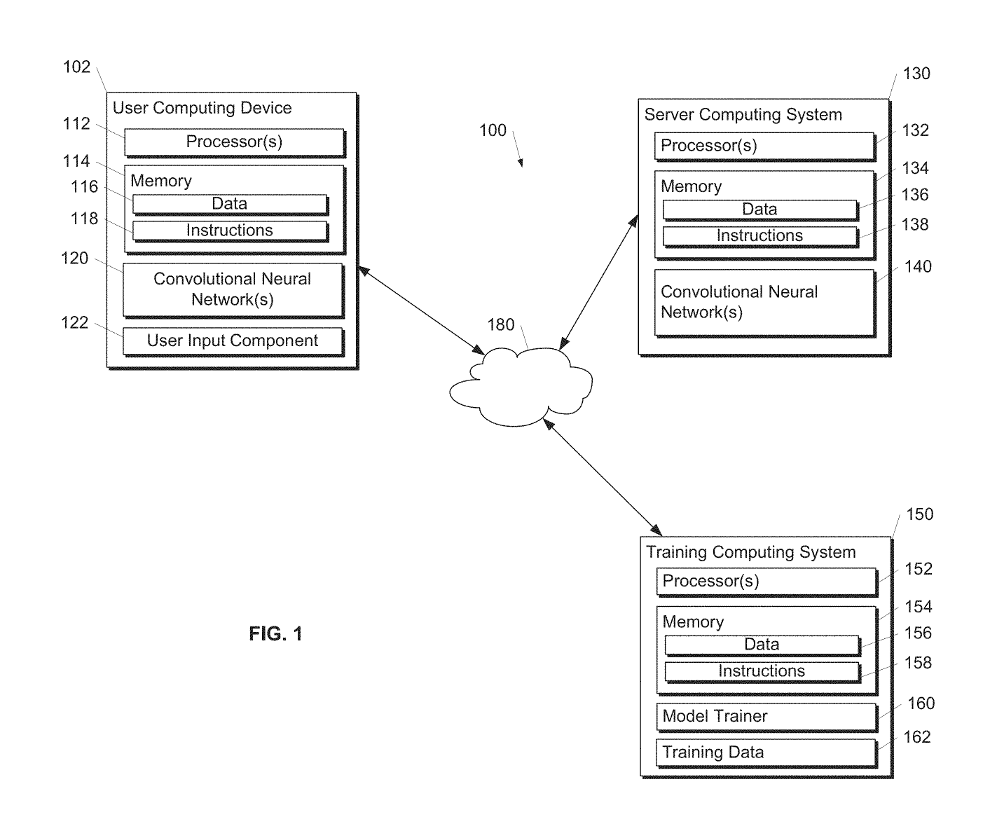

Referring now to the figures, example aspects of the present disclosure will be discussed in greater detail. For instance, FIG. 1 depicts a block diagram of an example computing system 100 that performs CNN compression techniques and/or incremental training techniques according to example embodiments of the present disclosure. The system 100 includes a user computing device 102, a server computing system 130, and a training computing system 150 that are communicatively coupled over a network 180.

For instance, the server computing system 130 can be configured to implement one or more network compression techniques in accordance with example aspects of the present disclosure. The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes multiple server computing devices, such server computing devices can operate according to sequential computing architectures, parallel computing architectures, or some combination thereof.

As described above, the server computing system 130 can store or otherwise includes one or more CNNs 140. For example, the CNNs 140 can include one or more convolutional layers, one or more pooling layers, and/or one or more fully connected layers. For instance, in some implementations, a pooling layer can separate two convolutional layers. Each layer can be configured to transform a three-dimensional (3D) input volume to a 3D output volume using some differentiable function that may or may not have parameters. The layers of the CNNs 140 can include a plurality of neurons arranged in three dimensions (e.g. width, height, and depth). The neurons in the convolutional layers are only connected to a small portion of the previous layer. In this manner, the convolutional layers can be configured to compute the output of the neurons that are connected to local regions in the input.

The convolutional layers are associated with a set (e.g. one or more) of learnable filters that act as parameters of the convolutional layer. The filters can be small spatially (e.g. along width and height dimensions). For instance, the filters can be the same size spatially as the receptive fields associated with the convolutional layer. Each convolutional layer can be convolved with the one or more filters to produce one or more activation maps.

As indicated above, the server computing system 130 can be configured to compress a CNN 140 by deactivating one or more connections between one or more filters associated with two or more convolutional layers of the CNN 140. In this manner, the server computing system 130 can randomly select a fraction α of connections to be deactivated if those parameters connect at least two filters on each layer. If the parameters connect layers with only one filter left, the server computing system 130 can select a fraction of the connections to be deactivated. Upon a selection of the connections to be deactivated, the server computing system 130 can deactivate the selected connections. For instance, in some implementations, the connections can be deactivated by applying a mask to the appropriate parameter tensors.

The server computing system 130 can train the CNNs 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the CNNs 140 stored at the server computing system 130 using various training or learning techniques, such as, for example, backwards propagation of errors. In some implementations, performing backwards propagation of errors can include performing truncated backpropagation through time. The model trainer 160 can perform a number of generalization techniques (e.g., weight decays, dropouts, etc.) to improve the generalization capability of the models being trained. In particular, the model trainer 160 can train a CNN 140 based on a set of training data 162.

In particular, the training computing system 1500 and/or the server computing system 130 can be configured to train the CNN 140 in an incremental manner by gradually increasing an amount of connections of the CNN 140. For instance, the server computing system 130 can initialize the CNN 140 for incremental training by deactivating all but a small fraction small fraction (e.g. 1%, 0.1%, etc.) of connections. The model trainer 160 may initiate a suitable training technique on the initialized CNN 140. The server computing system 130 can then incrementally increase the number of connections of the CNN 140, such that the model trainer 160 then performs the training on the CNN 140 having the increased number of connections. This process can be repeated one or more times such that the server computing system 130 gradually increases the number of connections in the CNN 140, and that the model trainer 160 trains the CNN 140 as the connections are gradually increased. It will be appreciated that the server computing system 130 may densify the CNN 140 in any suitable manner in accordance with various suitable training techniques used to train the CNN 140. For instance, the server computing system 130 may determine a densification scheme defining time intervals for increasing the connections, and an amount by which the connections will be increased. The densification scheme can be determined based at least in part on the training technique used by the model trainer 160 to train the CNN 140. The densification scheme can be further determined based at least in part on the parameters of the convolutional layers and/or a number of possible connections within the CNN 140.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 1A illustrates one example computing system that can be used to implement the present disclosure. Other computing systems can be used as well. For example, in some implementations, the user computing device 102 can include the model trainer 160 and the training dataset 162. In such implementations, the communication assistance models 120 can be both trained and used locally at the user computing device 102. In some of such implementations, the user computing device 102 can implement the model trainer 160 to personalize the communication assistance models 120 based on user-specific data.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

The user computing device 102 can store or include one or more CNNs 120. For example, the CNNs 120 can be CNNs having an architecture in accordance with example embodiments of the present disclosure. In some implementations, the one or more CNNs 120 can be received from the server computing system 130 over network 180, stored in the user computing device memory 114, and the used or otherwise implemented by the one or more processors 112. In some implementations, the user computing device 102 can implement multiple parallel instances of a single CNN 120.

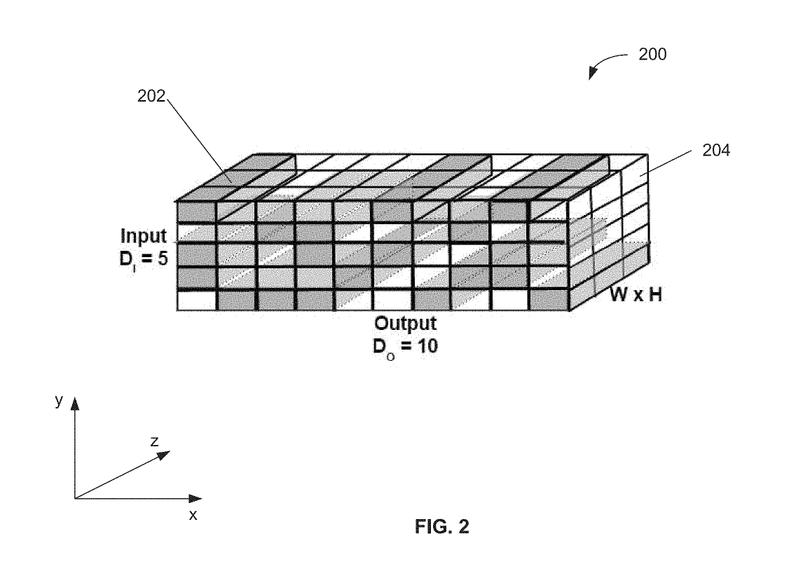

FIG. 2 depicts an example graphical representation of a connection pattern 200 in accordance with example aspects of the present disclosure. In particular, the y-axis represents the channels of an input layer D_{I}, and the x-axis represents the channels of an output layer D_{O}. The z-axis represents the spatial dimensions (e.g. width W and height H) of the layers. As shown in FIG. 2, the connection pattern 200 includes a plurality of activated connections 202 and a plurality of deactivated connections 204. The connection pattern 200 is a sparse connection pattern in accordance with example aspects of the present disclosure. In particular, the connection pattern 200 specifies connections for only a fraction of the possible connections between layer D_{I} and layer D_{O}. In this manner, each output filter associated with the layer D_{O} connects to only a fraction of filters associated with the layer D_{I}. As indicated above, the advantage of this is that the convolution can be computed quickly because the sparsity is introduced only at the outer loop of the convolution operation. In this manner, a continuous memory layout can be leveraged.

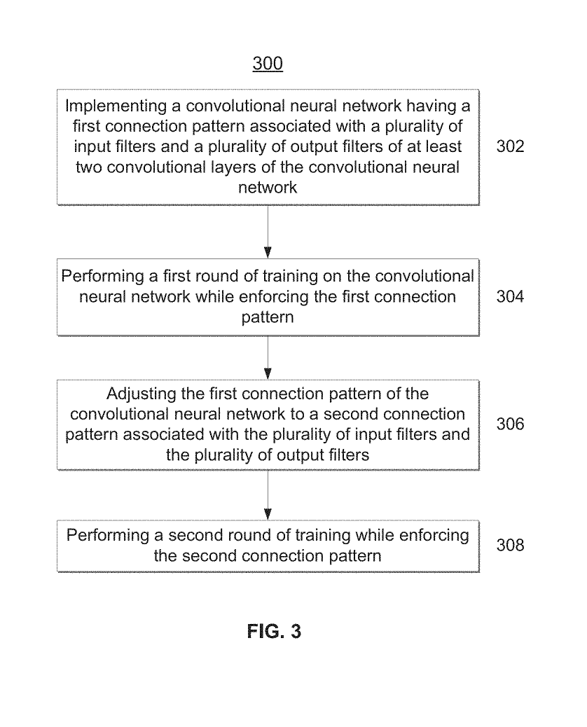

FIG. 3 depicts a flow diagram of an example method of training a convolutional neural network according to example embodiments of the present disclosure. The method (300) can be implemented by one or more computing devices, such as one or more of the computing devices depicted in FIG. 1. In addition, FIG. 3 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure.

At (302), method (300) can include implementing a convolutional neural network having a first connection pattern. The first connection pattern can be associated with a plurality of input filters and a plurality of output filters of at least two convolutional layers of the convolutional neural network. The first connection pattern can define a sparse, random connection pattern, wherein only a fraction of possible connections are established. In particular, the first connection pattern can specify one or more active connections and one or more inactive connections between the plurality of input filters and the plurality of output filters. In this manner, the first connection pattern can specify that the active connections only make up a first subset of the possible connections between the plurality of input filters and the plurality of output filters. In some implementations, the first subset can correspond to a small fraction (e.g. 1%, 0.1%, etc.) of the number of possible connections.

At (304), method (300) can include performing a first round of training on the convolutional neural network while enforcing the first connection pattern. The first round of training can be performed using various suitable training techniques. In this manner, the first round of training can be performed on the convolutional neural network implementing the first connection pattern.

At (306), method (300) can include adjusting the first connection pattern to a second connection pattern. In particular, the second connection pattern can specify one or more active connections and one or more inactive connections between the plurality of input filters and the plurality of output filters. In this manner, the second connection pattern can specify that the active connections only make up a second subset of the possible connections between the plurality of input filters and the plurality of output filters. The second subset can be a larger subset than the first subset, such that the number of active connections in the second subset is larger than the number of active connections in the first subset. In this manner, the second connection pattern can correspond to an increased amount of connections between the plurality of input filters and the plurality of output filters relative to the first connection pattern. In some implementations, the second connection pattern can correspond to an incrementally or gradually increased amount of connections.

At (308), method (300) can include performing a second round of training on the convolutional neural network while enforcing the second connection pattern. In this manner, the second round of training can be performed on the convolutional neural network implementing the second connection pattern.

It will be appreciated that one or more additional rounds of training can be performed on the convolutional neural network having further adjusted connection patterns. In this manner, the training can be performed in an incremental manner in accordance with a gradual or incremental increase in connections associated with the convolutional neural network.

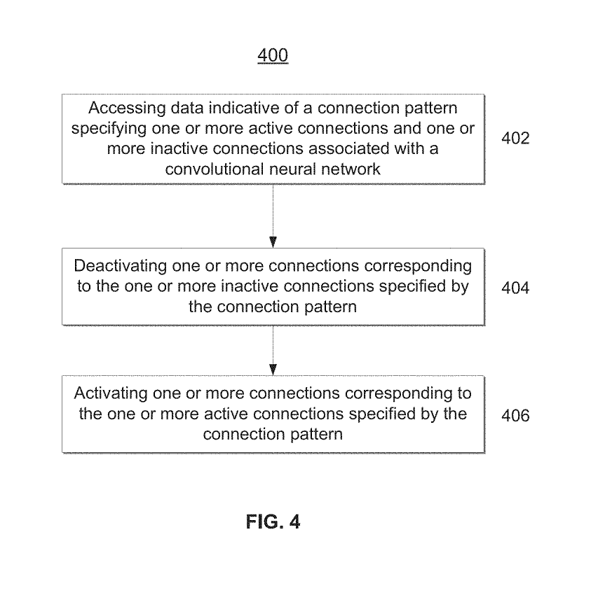

FIG. 4 depicts a flow diagram of an example method (400) for performing network compression according to example embodiments of the present disclosure. The method (400) can be implemented by one or more computing devices, such as one or more of the computing devices depicted in FIG. 1. In addition, FIG. 4 depicts steps performed in a particular order for purposes of illustration and discussion.

At (402), method (400) can include accessing data indicative of a connection pattern specifying one or more active connections and one or more inactive connections associated with a plurality of input filters and a plurality of output filters of two or more convolutional layers of a convolutional neural network. As indicated, the connection pattern can be determined by randomly selecting a fraction of connections to be activated and/or deactivated.

At (404), method (400) can include deactivating one or more connections corresponding to the one or more inactive connections specified by the connection pattern. In some implementations, the one or more connections can be deactivated by applying a mask to the parameter tensors associated with the appropriate filters.

At (406), method (400) can include activating one or more connections corresponding to the one or more active connections specified by the connection pattern. For instance, in some implementations the connection pattern can specify that a currently inactive connection is to be activated. In such instance, the currently inactive connection can be activated by removing a mask associated with the parameter tensors of the appropriate filters.

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A convolutional neural network, comprising:
an input convolutional layer having a plurality of associated input filters; and
an output convolutional layer having a plurality of associated output filters;
wherein the convolutional neural network implements a connection pattern defining connections between the plurality of input filters and the plurality of output filers, the connection pattern specifying that at least one output filter of the plurality of output filters is connected to only a subset of the plurality of input filters.

2. The convolutional neural network of claim 1, wherein the connection pattern specifies one or more active connections and one or more inactive connections between the plurality of input filters and the plurality of output filters.

3. The convolutional neural network of claim 2, wherein the one or more active connections comprise a small fraction of a total number of possible connections between the plurality of input filters and the plurality of output filters.

4. The convolutional neural network of claim 2, wherein the one or more active connections are determined randomly.

5. The convolutional neural network of claim 2, wherein the one or more inactive connections are determined randomly.

6. The convolutional neural network of claim 1, wherein the connection pattern is a sparse connection pattern.

7. The convolutional neural network of claim 1, wherein the input convolutional layer and the output convolutional layer comprise a plurality of neurons arranged in three dimensions.

8. The convolutional neural network of claim 1, further comprising one or more pooling layers and one or more fully connected layers.

9. The convolutional neural network of claim 8, wherein at least one pooling layer of the one or more pooling layers separates the input convolutional layer and the output convolutional layer.

10. One or more tangible, non-transitory computer-readable media storing computer-readable instructions that when executed by one or more processors cause the one or more processors to perform operations, the operations comprising:
accessing data indicative of a connection pattern associated with a convolutional neural network, the connection pattern defining connections between a plurality of first filters associated with a first convolutional layer and a plurality of second filters associated with a second convolutional layer, the connection pattern specifying that at least one of the plurality of second filters is connected to only a subset of the plurality of first filters;
deactivating one or more connections in the convolutional neural network corresponding to the one or more inactive connections specified by the connection pattern.

11. The one or more tangible, non-transitory computer-readable media of claim 10, wherein the connection pattern specifies one or more active connections and one or more inactive connections between the plurality of input filters and the plurality of output filters.

12. The one or more tangible, non-transitory computer-readable media of claim 11, wherein the one or more active connections comprise a small fraction of a total number of possible connections between the plurality of first filters and the plurality of second filters.

13. The one or more tangible, non-transitory computer-readable media of claim 11, wherein the one or more active connections are determined randomly.

14. The one or more tangible, non-transitory computer-readable media of claim 11, wherein the one or more inactive connections are determined randomly.

15. The one or more tangible, non-transitory computer-readable media of claim 10, the operations further comprising activating one or more connections associated with the one or more active connections specified by the connection pattern.

16. The one or more tangible, non-transitory computer-readable media of claim 10, wherein deactivating one or more connections in the convolutional neural network comprises applying masks one or more tensor parameters associated with each of the one or more connections.

17. A computer-implemented method of training a convolutional neural network, the method comprising:
performing, by one or more computing devices, a first round of a machine learning training on a convolutional neural network while enforcing a first connection pattern between a plurality of first filters and a plurality of second filters of at least two convolutional layers of the convolutional neural network, wherein the first connection pattern specifies, for each second filter, only a first subset of the plurality of first filters to which the second filter is connected; and
subsequent to performing the first round of machine learning training, performing, by the one or more computing devices, a second round of the machine learning training on the convolutional neural network while enforcing a second connection pattern between the plurality of first filters and the plurality of second filters of the at least two convolutional layers of the convolutional neural network, wherein the second connection pattern specifies, for each second filter, only a second subset of the plurality of first filters to which such second filter is connected, and wherein, for each second filter, the second subset includes a larger number of first filters than does the first subset.

18. The computer-implemented method of claim 17, further comprising implementing the convolutional neural network enforcing the first connection pattern.

19. The computer-implemented method of claim 17, further comprising adjusting the first connection pattern of the convolutional neural network to the second connection pattern.

20. The computer-implemented method of claim 17, wherein the machine learning training comprises a backpropagation technique.
